(19) United States
(12) Patent Application Publication
(10) Pub. No.: US 2003/0062231 A1
(43) Pub. Date: Apr. 3, 2003

(54) Process for braking a moving mass such as a braking and damping element

(76) Inventor: Wolgang Muller, Lustenau (AT)

Correspondence Address: Todd W. Galinski, Kilpatrick Stockton LLP, 1001 West Fourth Street, Winston-Salem, NC, 27101, US

(21) Appl. No.: 10/289,614

(22) Filed: Nov. 7, 2002

Related U.S. Application Data
(62) Division of application No. 09/729,659, filed on Dec. 4, 2000.

(51) Int. Cl. F16F 7/10

(52) U.S. Cl. 188/380

(57) ABSTRACT

The invention concerns a process for braking or decelerating a moving mass, as well as a suitable braking and damping element.

The invention distinguishes itself in that one or more surfaces are moistened with a highly viscous liquid-containing medium, that the braking and damping element always has a fixed part and a movable part, that after the mass impacts with the movable part, are moved against each other for a certain distance, so that the liquid-containing medium by its retention on the surfaces, puts out an inner molecular friction; whereby, the kinetic energy of the mass to be intercepted, is transferred in frictional heat.

### CROSS REFERENCE TO RELATED APPLICATIONS

This application is a Divisional Application of U.S. patent application Ser. No. 09/729,659, filed on Dec. 4, 2000, which claims priority to German Patent Application No. 199 59 051.6 filed on Dec. 13, 1999, both of which are herein incorporated by reference.

### FIELD OF THE INVENTION

The invention concerns a procedure for braking or decelerating a moving mass, as well as a suitable braking and damping element, according to the introductory characterizing clause of the individual independent patent claims.

### BACKGROUND OF THE INVENTION

Braking and damping elements are known in diverse embodiments in the technology and are used in different applications and fields.

So, among other things, hydraulic shock absorbers are known that have a piston-cylinder system with two working chambers between which a liquid medium flows that activates the braking effect. Dampers of this type have a high level of static friction, caused by piston rods and piston seals; this results in a significant reduction of structural sizes available. Furthermore, they are very costly and expensive to produce and are, therefore, used only for those special applications, where expenses play a subordinate role.

With furniture/cabinets, especially drawers and furniture/cabinet doors, friction-based braking and damping elements are usually used in connection with spring elements. Such braking elements are made known in DE 199 15 164 A1 or DE 197 17 937 A1.

These friction braking elements can lead, by their static friction, to the so-called Slip-Stick-Effect, which becomes apparent when the parts to be braked or decelerated rattle, vibrate, get stuck, etc. Likewise, abrasion plays a big role with friction dampers, especially when masses with high kinetic energy must be braked or decelerated.

### SUMMARY OF THE INVENTION

The task of the invention is a procedure to brake a moving mass and to propose a suitable braking and damping element that is simple and inexpensive, and that allows the braking of a moving mass over a certain distance with adjustable braking characteristics and nearly abrasion-free braking and deceleration.

The solution of this task takes place, according to the invention, via the features and characteristics described in the individual and independent patent claims.

The core of the invention is based on the facts that one or several surfaces are moistened with a highly viscous liquid containing medium; that, it always has a fixed and a mobile part of the braking and damping element, and these are moved against each other after the mass impacts on the movable part for a certain distance, so that the liquid-containing medium is set out to an inner molecular friction by its adhesion at the surfaces; whereby, the kinetic energy of the mass, which can be intercepted, is transferred in the frictional heat.

With the invention a higher speed can be used; it can be moved manually or with a foreign energy, guided linearly or turning stored mass of the type, to be intercepted, so that the kinetic energy of the mass is converted by a pre-selectable way and because of a structural design of a pre-selectable damping feature, without recoil in the predominantly friction heat. If desired, the remaining way can be returned up to a pre-set end stop with a certain, by a pre-selectable design, brake action with very little static friction without the Slip-Stick-Effect, if so chosen, supported by spring tension.

Advantageous embodiments and further developments of the invention are given in the dependent patent claims.

According to the invention a medium is inserted between the parts, which are movable in relation to each other. The medium's friction rate (coefficient of friction) depends on the speed or rate of the parts moving against each other (that is, the speed of the mass to be decelerated or braked). This is achieved by the application of a highly viscous medium that has a viscosity of several tens of thousands to several millions Pa's.

Therefore, because the coefficient of friction is low in smaller speeds, only a slight force (for example, spring tension) must be applied after braking or decelerating the mass, in order to move the mass up to a pre-selected end stop.

In an advantageous manner, the damping process can be adjusted by changing the distance and/or adjusting or changing the surface form. By axial profiling (that is, profiling in the movement direction of the movable part) the running of the mass' gap is guided between the “friction surface,” dependent upon the path of the mass, which results in a freely selectable damping curve (progressive, decreasing, tapering, linear, specific restraint). By radial profiling, for example, the surfaces of both parts that move against each other, are increased, which allows a smaller structural size. Axial profiling in combination with radial profiling leads to a smaller size with optimized damping features.

In a preferred embodiment, the invention has a recess or notch in any cross-section in one of the parts (for example, the fixed part of the braking and damping element), in which is held movable essentially the same cross-section properties of the other part (for example, the movable part), so that a gap is available between the surface of the notch and the surface of the movable part in which the medium is located. So the largest diameter of one of the parts is about double the gap width less than the smallest diameter of the notch into which it is guided.

Thus, the notch and/or the surface of the movable parts are profiled axially and/or radially, with which the structure size and/or damping characteristics can be influenced.

In another embodiment of the invention, the braking and damping element have several lamellas that move against each other. By inserting several thin, paired flat lamella elements that are connected to each other, there results an increase of effective surfaces with minimal structural shape. The flat elements can also be profiled in all dimensions to control the damping characteristics.

In another embodiment of the braking and damping element, the structure is formed as a shoe brake in the form of an inner or outer shoe brake. The effective surfaces can be pressed against a fixed surface, similar to a shoe brake, by at least two braking and damping elements through fixed gap dimensions or, especially, also by controlled gap size or gap compression. This design is suitable for the implementation as an inside or outside shoe brake.

As already mentioned, the lamella surfaces and/or shoe brakes and/or the respective opposing surfaces can be profiled.

Another embodiment provides, instead of a linearly moving braking and damping element, that the movable part is formed as a revolving rotation part in the fixed part. The movable part also executes a rotation movement, which is caused by the impact of the mass. Eventually, a reversing mechanism must be provided between the moving mass and the movable part.

After the completed braking and damping cycle, it can be provided that the braking and damping element can go back again to its normal (starting) position. This is, according to the invention, achieved with an activated pull-back member on the movable part.

In the advantageous manner, the pull-back member is designed as a spring element. It can be a separate tension or compression spring that engages on the active part and the braking and damping element can be reset with minimal force for the next braking and damping cycle. The pull-back force can be set very low, because with many application cases, there must be sufficient time available to pull back to the normal position for the next braking and damping cycle.

Additionally, in a further development of the invention, a pull-back free-running is provided that forces the lifting or release of the braking action. The pull-back free-running is achieved by forced guided load alleviation of the surface pressure or increasing the surface distance between both parts, for example. A braking and damping effect can be undesirable for technical application reasons concerning pulling back the mass to be braked, making a free-running necessary. This is achieved by directionally changing or adjusting the damping or absorbing action by the pair of surfaces in the gap's dimensions.

Furthermore, a buffer made of elastic and/or springy material is placed between the mass to be braked or decelerated and the movable part of the braking and damping element. The buffer is attached or located, as desired, on one of the touching parts, and serves to dampen the noise of impact when the mass to be braked or decelerated meets the braking or damping element. The impact of the mass on the active damping part causes a noise, also resulting from the low mass of the damping part and can be minimized by means of a rubber-type or springy-designed soft buffer part (for example, plastic part), integrated into the available part.

Naturally, the recommended braking and damping element can be combined with other braking and damping devices.

The invention-related braking and damping element has a wide range of applications (for example, in hinges, drawer slides, furniture hardware, etc.).

The invention is subsequently more closely described by several embodiments examples, at hand, with reference to the drawings. Further characteristics, features and advantages of the invention are given in the drawings and their descriptions.

### BRIEF DESCRIPTION OF THE DRAWINGS

FIG. 1: a schematic perspective view of braking and damping elements in a first embodiment;

FIG. 2: a sectional representation of the braking and damping element in an embodiment with integrated pull-back member;

FIG. 3: a further embodiment of the braking and damping element with pull-back member;

FIG. 4: a sectional representation of an embodiment of the braking and damping elements with profiled surfaces;

FIG. 5: a sectional representation of an embodiment of the braking and damping elements with profiled surfaces;

FIG. 6: an embodiment of the braking and damping element with several, lamella-type parts that are able to move against each other;

FIG. 7: an embodiment of the braking and damping element with a shoe brake in one of the slides;

FIG. 8: an embodiment of the braking and damping element with an operating shoe brake in one of the running surfaces;

FIG. 9: an embodiment of the braking and damping element with a rotary-operated movable part;

FIG. 10: an embodiment of the braking and damping element, integrated in a catch device for drawer rails.

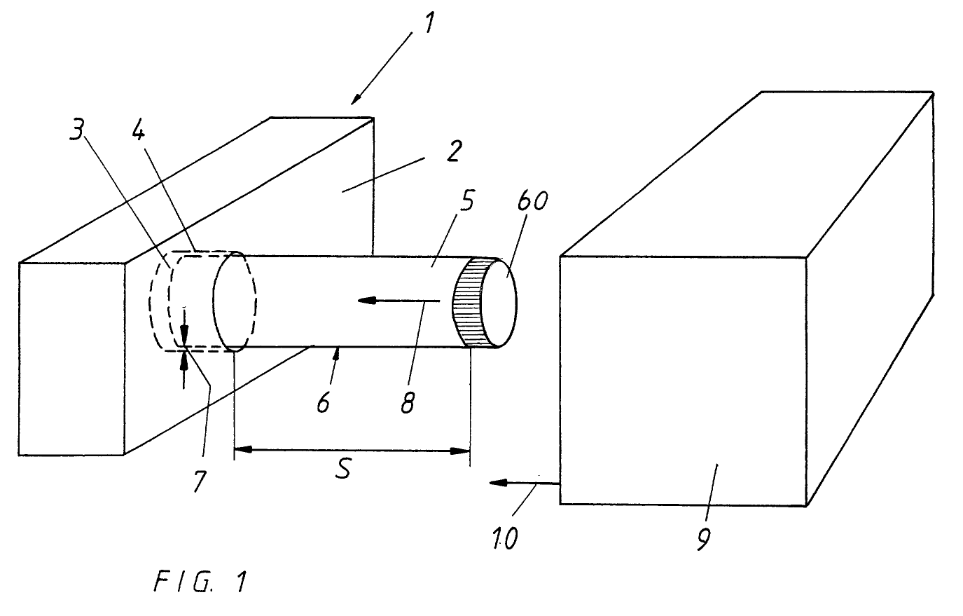

FIG. 1 shows an embodiment of the braking and damping element (1), which essentially consists of a fixed part (2) and, opposite the fixed part (2), a movable part (5). The fixed part (2) has a notch (in this case, a bore hole [3]) into which the (for example, cylindrically designed) movable part (5) is guided. The diameter of the bore hole (3) is slightly larger than the outer diameter of the movable part (5) so that a gap (7) remains between the bore hole's (3) surface (4) and the movable part's (5) surface (6). The surfaces (respectively 4 or 6) are moistened with a highly viscous medium, which basically fills up the gap (7). The highly viscous medium holds to the moistened surface (4,6) and resists the motion of the parts (2,5), that move to each other, depending on the viscosity of the medium, the gap's width (7) and the speed the parts (2,5) are moving towards each other. With this braking and damping element (1), a moved mass (9), which moves in arrow direction (10), should be braked or decelerated within a certain distance s. In the normal (starting) position of the braking and damping element (1), the movable part (5) is pointed in the direction of the mass (9) to be braked or decelerated and projects out around the distances from the bore hole (3) of the fixed part (2). Then the mass (9) meets the movable part (5), so the highly viscous medium by its retention to both surfaces 4,6) is released by an inner molecular friction, which transfers the kinetic energy of the mass (9) to be intercepted in friction heat and decelerates or brakes the mass (9) within the distance s. The movable part (5) then moves in the arrow direction (8) into the bore hole (3) of the fixed part (2) and, in fact, within this distance s.

Furthermore, a buffer (60) made of elastic and/or springy material is placed between the mass to be braked or decelerated (9) and the movable part (5) of the braking and damping element (1). The buffer (60) is attached or located, as desired, on one of the touching parts, and serves to dampen the noise of impact when the mass to be braked or decelerated (9) meets the braking or damping element (1). The impact of the mass on the active damping part causes a noise, also resulting from the low mass of the damping part and can be minimized by means of a rubber-type or springy-designed soft buffer part (for example, plastic part), integrated into the available part

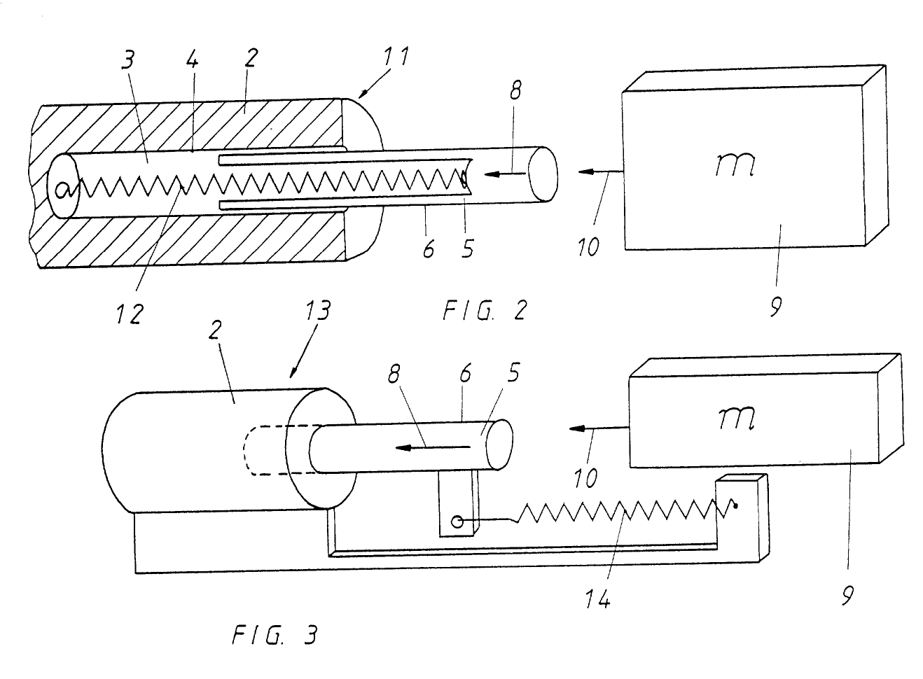

FIGS. 2 and 3 show, with regard to FIG. 1, a somewhat modified schematic embodiment of the braking and damping element (11, as well as 13). The braking and damping element (11) includes again a fixed part (2) with a cylindrical bore hole (3), in which the movable part (5) partially inserts or dips. By the impingement of the movable part (5) with the mass (9) to be braked in the arrow direction (10), the movable part (5) inserts in the arrow direction (8) in the bore hole (3) of the fixed part (2). To return the movable part (5) in its exit position (as shown in FIG. 2), the movable part is partially formed as a hollow cylinder; whereby, there is a compression spring (12) that is located between the movable part (5) and the base of the bore hole (3), which is sized accordingly, the friction force overcomes the movable part again and puts it back in the normal (starting) position. The duration, which is necessary for the pull-back position, depends, naturally, on the selected spring force and can, according to the application purpose, be selected.

FIG. 3 essentially shows the same principle as in FIG. 2; however, here has a tension spring (14) inserted as a pull-back member. The tension spring (14) is located between a set point and the movable part (5).

The braking and damping characteristics of the braking and damping element can be controlled by profiling the surface form of the parts that move to each other. To this, FIG. 4 shows a braking and damping element (15), whose surface (16) of the fixed parts has a certain axial profile (that is, whose cross-section adjusts itself according to the penetration depth). In exactly the same way, the movable part of the braking and damping element has a profiled surface (17), which works together with the profiled surface (16) of the fixed part in the desired manner. Now the movable part is pushed in the arrow direction into the notch of the fixed part by the force of a mass to be decelerated or braked, so, according to the position of the movable part, the width of the gap (18) is adjusted or modified; whereby, the braking force changes accordingly. So a freely chosen damping characteristics can be achieved, which can, for example, have a progressive, decreasing, linear or another specific function.

FIG. 5 shows a radial profiling of the motion of damping element (20); whereby, the notch or recess in the fixed part of the damping element (20) has, respectively, the profiling (22) of the shaped profiling (21). This radial profiling serves to enlarge the surface, that makes it possible to reduce the size of the braking and damping element (20).

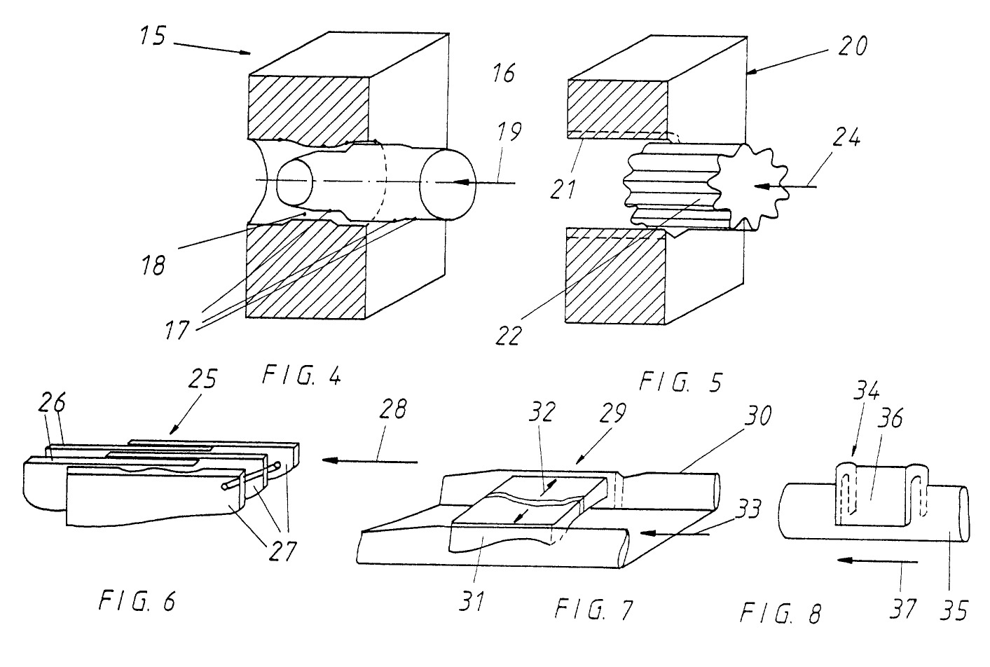

FIG. 6 shows another design of a braking and damping element (25), consisting of several fixed, essentially straight-formed, thin lamellas (26) and, corresponding, essentially straight-formed, thin, movable lamellas (27); whereby, the surfaces of the mutually related lamellas (26, 27) are moistened with the highly viscous medium. The operation is identical to that described above. When the lamellas (26, 27) are moved against each other (for example, by force activated in arrow direction [28]), the braking operation is activated when it touches the inner molecular friction of the highly viscous medium.

FIG. 7 shows another embodiment of a braking and damping element (29), according to a shoe brake principle. It is shown in one example as having a u-shaped running surface (30), in which a shoe brake (31), that can be slid, is placed. The width of the shoe brake (31) is chosen so that gap remains between the shoe brake and the wall of the running surface (30); the gap is moistened with the highly viscous medium. If the shoe brake (31) (for example, in arrow direction [33]) moves opposite the running surface (30), the braking action described above takes place. Then a fixed gap dimension or, especially, also a controlled gap dimension are used, so that (for example, the shoe brake [31]), the shoe brake is designed in two parts and each part is pressed by a corresponding device in arrow direction (32) against the running surface (30). The more the pressure is asserted, the smaller the gap is and the more the brake is activated.

FIG. 8 shows a braking element (34) in the form of an outer brake shoe with a running surface (35) on which a shoe brake is placed. The running surfaces (that is, the shoe brake's inner surface) are moistened with the highly viscous medium so that a force activation in arrow direction (37) of the brake cycle is released.

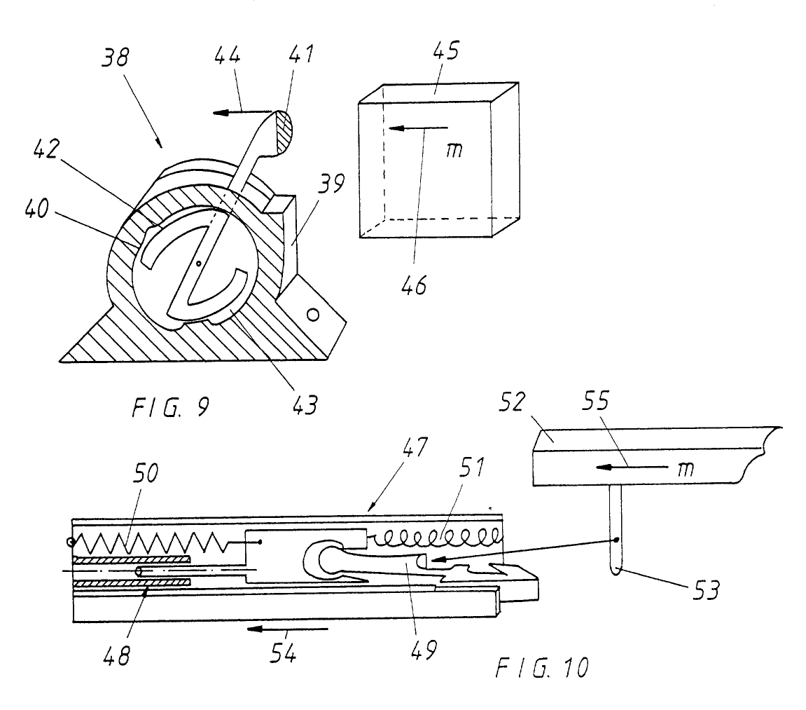

In contrast to a linear braking movement, as previously described in the embodiment examples, FIG. 9 shows an embodiment of a braking element (38) in which a movable part (41) is guided, able to turn inside a fixed part (39). Between the inner surface (40) of the fixed part (39) and the outer surface (42) of the movable part (41), the gap (43) is formed in a known manner, which is essentially filled with a highly viscous medium. A mass to be decelerated or braked (45) impacts in arrow direction (46) on the movable part (41), which then moves around its rotation axis in arrow direction (44) and the mass (45) brakes.

FIG. 10 shows a catch device (47) for drawers, which is equipped with an invention-related braking and damping element (48). The catch device (47) has a half-open casing in which a catch lever (49) in arrow direction (54) (respectively, in the opposite direction) is guided slidably. The braking and damping element (48) is essentially designed according to the previously described FIG. 2, as well as FIG. 3. The movable mass (52) is concerned with a drawer that is equipped with a catch pin (53), which engages in the catch lever (49) when the drawer is closed. As a result, the catch lever (49) moves in arrow direction (54) with the speed of the mass (52); as a result of which the braking operation of the braking and damping elements (48) is activated and the mass (52) brakes. By means of spring force with a tension spring (50) or, respectively, a compression spring (51), the mass (52) moves actively up to the end stop. The movement's speed can be freely chosen by the design lay-out of the damper's resistance to the braking and damping element (48), as well as by the spring's strength.

### Drawing Legend

1. Braking and damping element

2. Fixed part

3. Bore hole

4. Surface

5. Movable part

6. Surface

7. Gap/distance

8. Arrow direction

9. Mass

10. Arrow direction

11. Braking and damping element

12. Compression spring

13. Braking and damping element

14. Tension spring

15. Braking and damping element

16. Surface (fixed)

17. Surface (movable)

18. Gap/distance

19. Arrow direction

20. Braking and damping element

21. Surface (fixed)

22. Surface (movable)

23. Gap/distance

24. Arrow direction

25. Braking and damping element

26. Lamellas (fixed)

27. Lamellas (movable)

28. Arrow direction

29. Braking and damping element

30. Running surface

31. Brake shoe

32. Force

33. Arrow direction

34. Braking and damping element

35. Running surface

36. Brake shoe

37. Arrow direction

38. Braking and damping element

39. Fixed part

40. Surface

41. Movable part

42. Surface

43. Gap/distance

44. Arrow direction

45. Mass

46. Arrow direction

47. Catch device

48. Braking and damping element

49. Catch lever

50. Tension spring

51. Compression spring

52. Mass

53. Pin

54. Arrow direction

55. Arrow direction

60. Damping element

What is claimed is:

1. A process for controlling the braking of a moved mass by means of a braking and damping element, comprising: providing one or more surfaces, wherein the one or more surfaces are moistened with a highly viscous liquid-containing medium, the braking and damping element having a fixed part and a movable part, wherein after the moved mass impacts with the movable part and the moved mass and the movable part are moved against each other for a certain distance, the highly viscous liquid-containing medium by its retention on the one or more surfaces puts out an inner molecular friction; whereby, the kinetic energy of the moved mass is transferred in frictional heat; the process further comprising providing a buffer, wherein the buffer is made form an elastic material that is located between the moved mass which is to be braked or decelerated and the moveable part of the breaking and damping element.

2. The process, according to claim 1, wherein the highly viscous liquid-containing medium comprises a coefficient of friction that depends on the speed at which the moved mass and the movable part move to each other.

3. The process, according to claim 1, wherein the braking and damping element controlling the deceleration or braking of the moved mass comprises at least one fixed part and one movable part; whereby, the movable part is subjected to the moved mass, which can be decelerated, and in relation to the fixed part, is movable opposite the fixed part for a defined distance; whereby, the fixed part and the movable part have one or more receptive surfaces related to one another, and these surfaces are moistened with the highly viscous liquid-containing medium.

4. The process, according to claim 3, wherein the coefficient of friction of the highly viscous liquid-containing medium is dependent upon the speed of the fixed part and the movable part that are movable in relation to each other.

5. The process, according to claim 3, wherein at least one of the fixed part and the movable part comprises a recessed notch in a cross-section in which the other part essentially has the same cross-section; whereby, a gap is located between a surface of the recessed notch and a surface of the part that has been taken up, in which the highly viscous liquid-containing medium is located.

6. The process, according to claim 5, wherein the largest diameter of one of the fixed part and the movable part is less than about double the gap's width, so it can be inserted into the smallest diameter of the recessed notch.

7. The process, according to claim 5, wherein the notch has a uniform cross section throughout, and the cross section of the other part which is inserted into the notch has a uniform cross section throughout, such that the gap between the fixed and moveable parts, containing the highly viscous fluid, is of consistent width.
